(19) United States
(12) Patent Application Publication
(10) Pub. No.: US 2008/0006746 A1
(43) Pub. Date: Jan. 10, 2008

(54) Collapsible support stand

(75) Inventor: Vladimir Volochine, Safety Harbor, FL (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: OnScreen Technologies, Inc., Safety Harbor, FL (US)

(21) Appl. No.: 11/481,791

(22) Filed: Jul. 7, 2006

(51) Int. Cl. F16M 11/38

(52) U.S. Cl. 248/169

(57) ABSTRACT

A collapsible support stand includes a base upon which a weight may be placed for stability. A foundation plate is rotatably attached to the base and is coupled to a telescoping column. The telescoping column includes multiple tubes nestable within one another. The stand also includes a leveling system having multiple knobs that, when rotated, may adjust the angle of the post relative to the foundation plate and base.

### TECHNICAL FIELD

The application generally relates to structures that can be used to support signs that can be rapidly deployed in response to relatively quickly changing conditions. The application further relates to structures that can be folded and are easily portable.

### BACKGROUND

A variety of roadway or emergency situations have occurred over recent years that underscore the need for Rapid Dispatch Emergency Signs (RDES) or Rapid Dispatch Incident Management Signs (RDIMS) that get highly visible messaging to critical places quickly. Examples of such situations include traffic problems and road construction, as well as much more serious occurrences (e.g., the terrorist attacks of Sep. 11, 2001, the New York blackout, the Southern California fires, etc.). In these and other situations, authorities need to advise large groups of people where to go, what to do, etc. An illuminated sign or other display is often an ideal way to provide such information. If authorities can quickly move a portable illuminated display to where it is needed, hazardous or potentially hazardous situations can be better addressed.

Conventional illuminated signs are often bulky and difficult to erect. In response, newer signs that are lightweight and easily transported are being developed. Accordingly, there is a need for a support stand, to be used with these newer signs, that is similarly lightweight and portable.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

At least some embodiments include a portable and collapsible support stand for use with, e.g., a sign or display. The stand may be formed of lightweight materials, such as durable plastic, aluminum (or other lightweight metal), etc. The stand can be placed into a stowed configuration, in which it takes up relatively little space and may be easily transported, or a deployed position, in which it may durably support a sign or other type of display.

The stand includes a base that provides a surface on which a load (such as sandbags, a battery, tools, accessories or a vehicle) may be placed for added stability. The base may include raised edges to aid in maintaining the position of the load. A foundation plate is rotatably attached to the base and coupled to a telescoping column. The column may include one or more telescoping tubes. A gas spring biasing system, having opposing, lockable gas springs, may be used to ease raising and lowering of the telescoping tubes.

A stand according to at least some embodiments also includes a leveling system. The leveling system includes a plurality of leveling screws with knobs arranged beneath the telescoping column that, when rotated, adjust the angle of the column relative to the base. The vertical angle of the column may be indicated by tubular levels positioned on one or more sides of the column.

The stand may further include a plurality of support legs that are attached to a sliding collar that surrounds a portion of the telescoping column. The sliding collar may be adjusted along the length of the column by aligning it with any of a plurality of receiving holes arranged along the length of the column. A locking pin then interacts with one of the holes to secure the collar in position. The support legs attached to the sliding collar unfold and extend away from the telescoping column to add stability to the stand.

Additional features and advantages of various embodiments are further described below.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the invention.

FIG. 1 is a perspective view showing a collapsible support stand, in a deployed configuration and coupled to a sign, according to at least one embodiment.

FIG. 2 is an enlarged view of the support stand of FIG. 1.

FIG. 3 is a rear end perspective view showing the collapsible support stand of FIG. 1 in a stowed configuration.

FIG. 4 is a front end perspective view of the support stand shown in FIG. 3.

FIG. 5 shows the support stand of FIG. 1 as the column is rotated into an upright position.

FIG. 6 shows the support stand of FIG. 1 with the column in an upright position.

FIG. 7 is a front perspective view of the collapsible support stand of FIG. 1 with the support legs partially unfolded.

FIG. 8 is a detailed view of the leveling system of the collapsible support stand of FIG. 1.

FIG. 9 is an exploded view of the leveling system shown in FIG. 8.

FIG. 10 shows the leveling system of FIG. 8 as it may be appear when it has been adjusted.

FIG. 11 is a cross sectional view of the collapsible support stand of FIG. 1.

FIG. 12 is an enlarged view of the gas spring arrangement within the collapsible support stand of FIG. 1.

FIG. 13 is an enlarged view of the upper portion of the support stand of FIG. 11 showing the gas spring biasing system.

FIG. 14 is an enlarged view of the lower portion of the support stand of FIG. 11 showing the gas spring biasing system.

FIG. 15 is an enlarged view of the interface between the collapsible support stand of FIG. 1 and a sign.

FIG. 16 is a cross-sectional view of the interface of FIG. 15.

### DETAILED DESCRIPTION

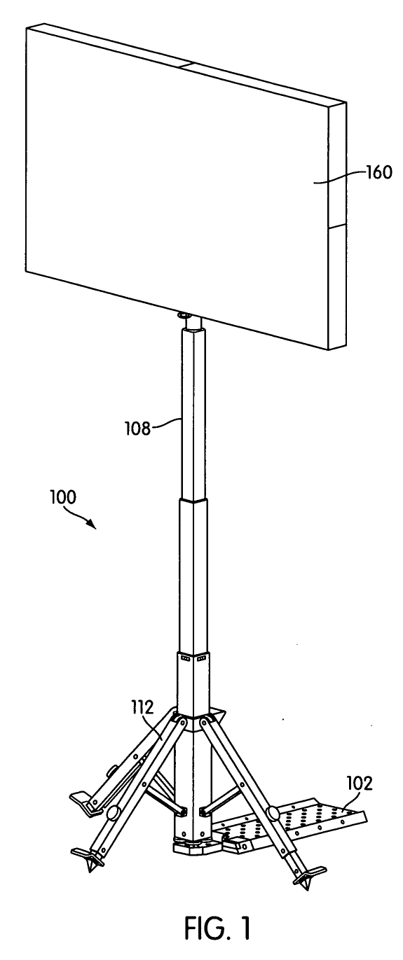

FIG. 1 is a perspective view of a collapsible stand 100 according to at least one embodiment. The collapsible stand 100 is shown in a deployed position and coupled to a sign 160. Although sign 160 is shown to illustrate one potential use of stand 100, stands according to the invention can be used for numerous other purposes. The collapsible stand 100 is lightweight and can be deployed in a variety of environments and conditions, such as on a roadway under construction, at a sporting event where traffic may have an irregular flow, etc. The sign 160 is coupled to the stand and can be removed with relative ease to allow the stand 100 to collapse to a stowed configuration.

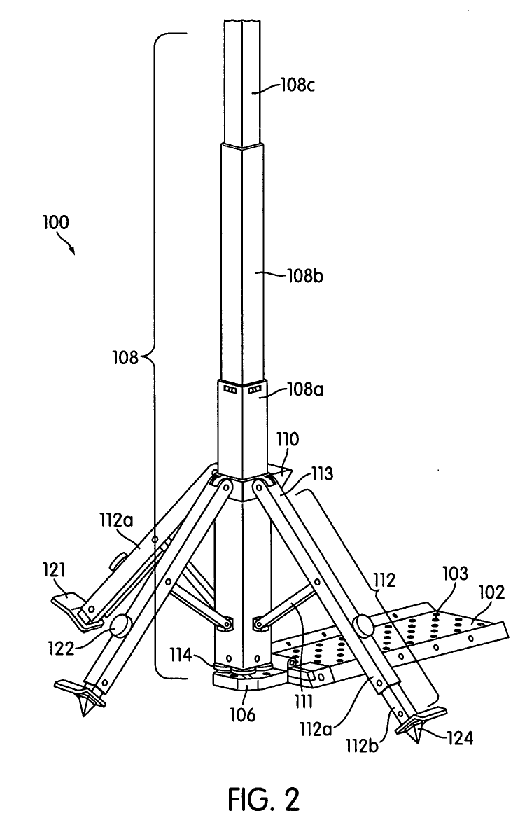

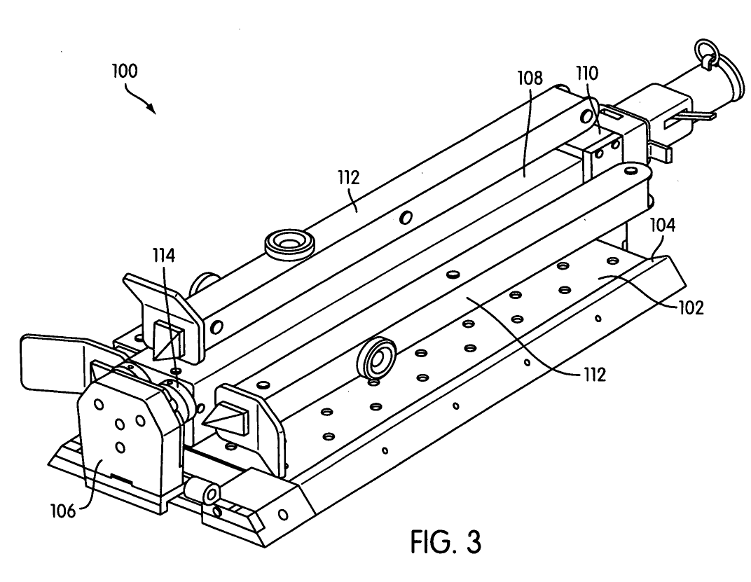

FIG. 2 is an enlarged view of the collapsible stand 100 of FIG. 1, with sign 160 and the upper portion of one tube omitted for clarity. The stand 100 includes a base portion 102 onto which a load, such as sandbags, tools, accessories, a battery, or a vehicle, may be placed. In particular, the base 102 is generally flat and contacts the ground (or other surface) on which the stand 100 is positioned. A load is then placed onto the receiving area 103 so as to hold stand 100 in place. The base 102 is attached to a foundation plate 106 that can rotate from a position generally perpendicular to the base 102 (as shown in subsequent FIG. 3) to a position generally parallel to the base 102 (as shown in FIG. 2). An extendible column 108 is coupled to the foundation plate 106. Column 108 includes a main tube 108a, and telescoping tubes 108b and 108c that alternatively nest within or extend from main tube 108a. Although sections of column 108 are referred to as “tubes,” it is to be expected that one or more of those sections may not have a round cross-section. The telescoping tubes 108b, 108c are raised and lowered via a gas spring biasing system (not shown in FIG. 2 but discussed below), having opposing, lockable gas springs. Stand 100 also includes three extendable support legs 112. Each support leg 112 includes main outer leg 112a and an inner leg 112b that alternately extends from or retracts within the main outer leg 112a. The position of each inner leg 112b relative to its corresponding outer leg 112a is secured by a knob 122 (described in more detail below). The main outer leg 112a of each support leg 112 is coupled to stand 100 in two locations. Specifically, an upper end 113 of each main outer leg 112a is pivotally attached to a sliding collar 110. A linkage 111 is pivotally coupled to each main outer leg 112a approximately halfway along the length of the main outer leg 112a. The opposite end of each linkage 111 is then pivotally coupled to main post 108a. A leveling mechanism 114 is arranged between the foundation plate 106 and the base of the telescoping column 108 to provide fine leveling adjustments to the column and facilitate use of stand 100 on inclined surfaces. Additional details of the leveling system 114 are discussed below.

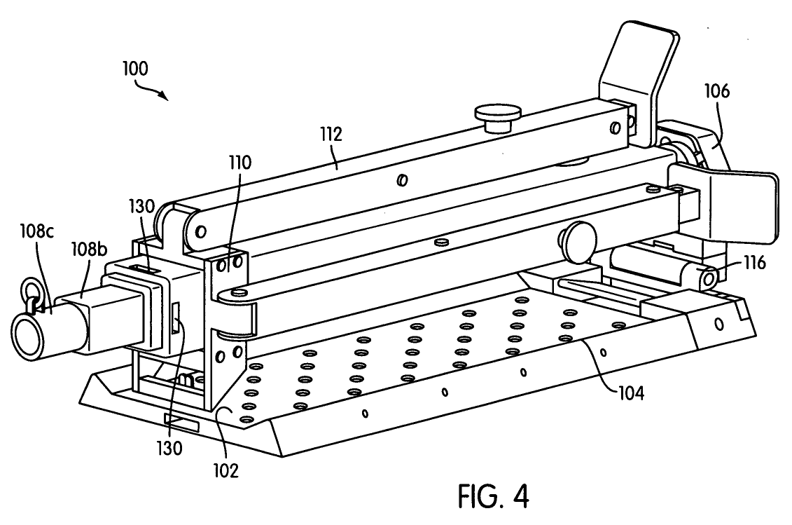

FIGS. 3-7 depict the stand 100 as it is being deployed. FIGS. 3 and 4 show the stand 100 in a stowed configuration. FIG. 3 is a rear perspective view of the stand 100 in a fully collapsed configuration. Specifically, tubes 108b and 108c are retained within tube 108a. Additionally, inner support legs 112b are drawn into outer support legs 112a and each support leg 112 is folded against main tube 108a. Foundation plate 106 is shown pivoted into a position generally perpendicular to base 102, thereby placing column 108 in a position generally parallel to the base 102. FIG. 4 shows a front perspective view of the stand 100 of FIG. 3.

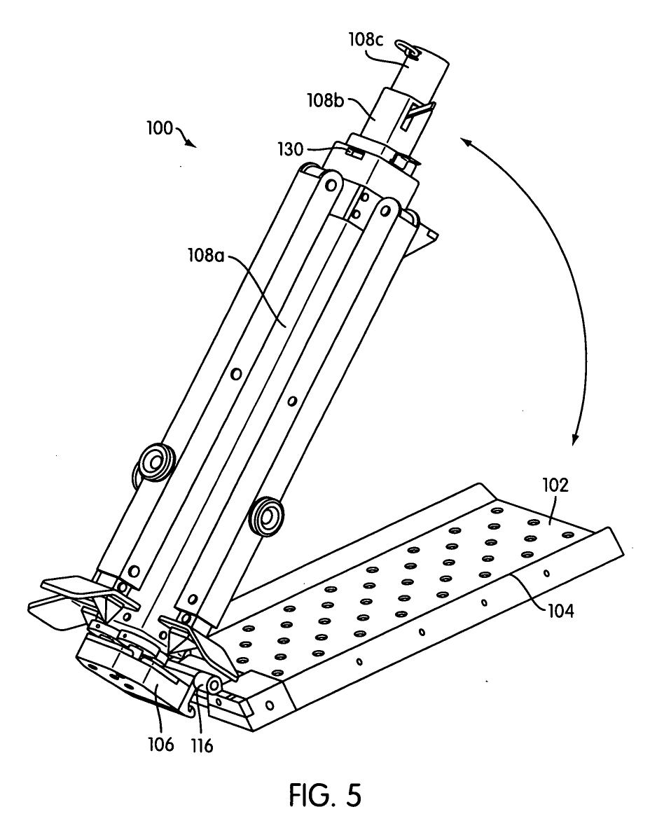

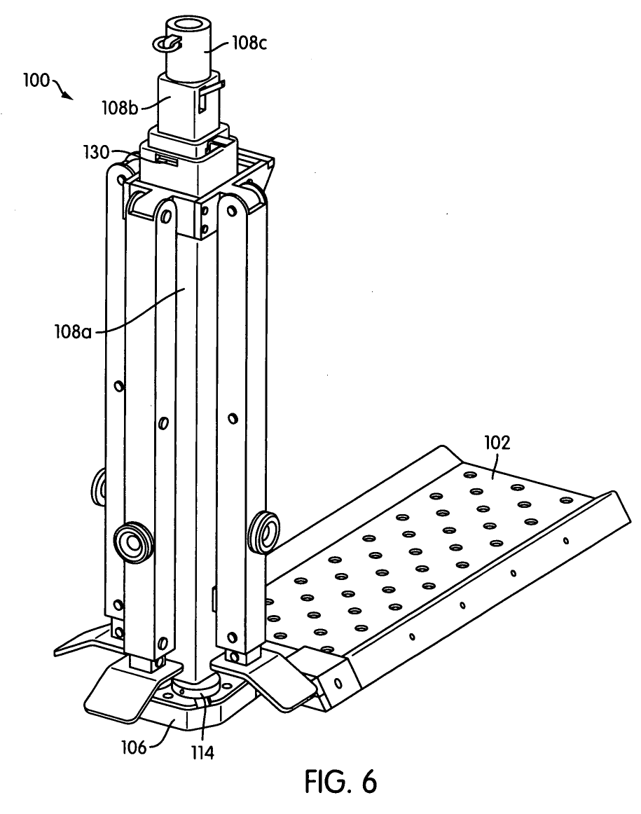

To deploy the stand, the foundation plate 106 is first rotated to a position generally parallel to the base 102, as the base 102 remains in contact with the surface. FIG. 5 depicts the foundation plate 106 and column 108 as they are rotated from a stowed position to the deployed position. FIG. 6 shows the position of the column 108 and foundation plate 106 in a partially deployed configuration, with column 108 in an upright position. Once the column is rotated into an upright position, the column is latched into place. The latch (not shown) may be any suitable latching device, such as a rotary latch, that will maintain the upright position of the column 108. The telescoping column 108 may then be extended to the desired height and may be leveled using the leveling system 114, discussed in detail below.

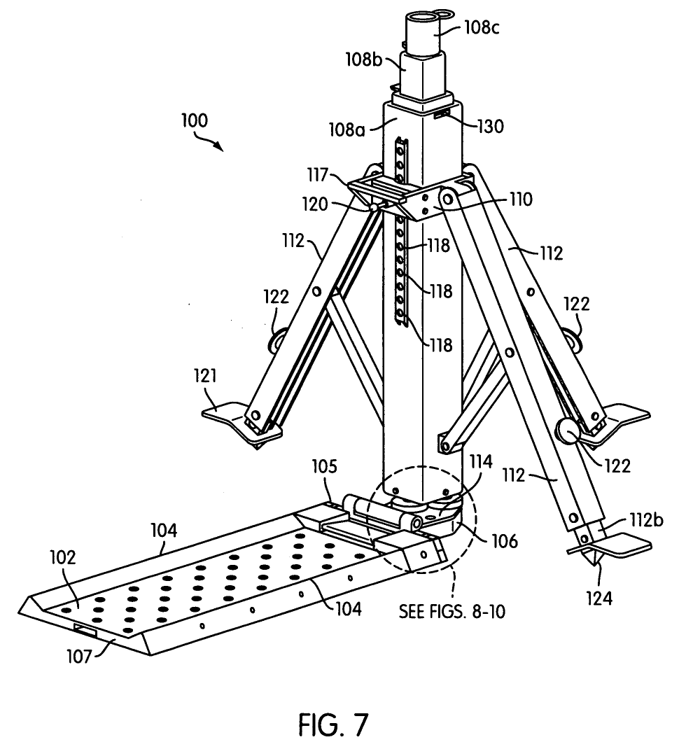

Once the telescoping column 108 and foundation plate 106 have been rotated into position, as in FIG. 6, the support legs 112 are spread, as shown in FIG. 7. In order to do this, the locking pin 120 holding the sliding collar 110 is removed. The sliding collar 110 is moved downward, along the length of main tube 108a, to force the legs 112 out and away from the column 108. Once the generally desired position is achieved, the sliding collar 110 is aligned with one of the plurality of receiving holes formed on the main tube 108a. The locking pin 120 is then replaced by extending it through the sliding collar and into the desired receiving hole. If desired, the legs 112 may be further extended by loosening the release knobs 122. The knobs 122 attach to screws that extend inward and maintain the positions of inner legs 112b with respect to outer legs 112a. The release knobs 122 are tightened to maintain the position of the inner support legs 112b.

To ensure stability of the stand in soft ground, feet 124 are formed at the end of the inner support legs 112b. To ensure the feet 124 have penetrated the ground, step tabs 121 are coupled to the inner support legs 112b above the feet 124. The user may step on the step tabs 121 to further press the feet 124 into the ground. FIG. 7 shows the stand 100 in a partially deployed position. The support legs 112 have been partially spread. The stand 100, once fully deployed, may appear as shown in FIG. 2. The column 108 is extended and inner support legs 112b are also partially extended from outer support legs 112a. A load may be placed on top of the base 102 to add stability to the stand 100.

To stow the stand 100, tubes 108b and 108c are collapsed into tube 108a. Then, the inner support legs 112b are returned to their nested position within outer support legs 112a by loosening the release knobs 122 and sliding inner support legs 112b into outer legs 112a, then tightening the release knob 122. The sliding collar 110 is then moved up, toward the top of the main post 108a, to cause the support legs 112 to collapse against the telescoping column 108. The sliding collar 110 is secured with the locking pin 120. The latch maintaining the upright position of the column 108 is then released and the foundation plate 106 and column 108 are then rotated to a position parallel to the base 102. In this stowed configuration, the stand 100 may be easily placed in a vehicle or other small area for storage until needed.

Referring again to FIG. 7, the base 102 is sized to accommodate a load placed in the receiving area. In one example, the base may be at least 24 inches in length from the rear end 105 to the front end 107. Several types of loads may be placed onto base 102. For example, sandbags, tools, work accessories, a battery, a vehicle or other weighted objects may be placed on the base 102 to help maintain the position of the stand 100. The base 102 includes raised edges 104 that provide a generally concave surface to maintain the position of the load.

The base 102 may be formed of any suitable material that can sustain heavy weights, such as durable plastic or metal. For example, the base 102 may be formed of aluminum to provide a strong, durable foundation while being lightweight and portable.

Referring again to FIG. 3, the collapsible stand 100 includes a foundation plate 106 that is rotatably connected to the base 102. The foundation plate 106 is in a position generally perpendicular to the base 102 when the stand 100 is in a stowed configuration, as in FIG. 3, and generally parallel to the base 102 when the stand 100 is in a deployed configuration, as in FIG. 7. The foundation plate 106 provides a platform to which telescoping column 108 is coupled. The telescoping column 108 is coupled to the foundation plate 106. This coupling arrangement may include interconnecting parts between the telescoping column 108 and foundation plate 106. In some embodiments, and as discussed below, these interconnecting parts form a leveling system for adjustment of the column to a desired vertical orientation.

As shown in FIG. 5, a hinge 116 attaches base 102 to foundation plate 106. The hinge 116 allows the plate 106 to be rotated to a position generally parallel to the base 102 in the deployed configuration (see FIG. 7).

Referring again to FIG. 7, and as previously described, the telescoping column 108 includes multiple tubes 108a-108c. The first tube 108a is coupled to the foundation plate 106. In addition, the column 108 includes a second tube 108b, nested within the first tube 108a that may be raised or lowered using a biasing system (not shown in FIG. 7) as discussed below. In one arrangement, the telescoping column 108 includes a third extension tube 108c, nested within the second extension tube 108b. The third extension tube 108c may also be raised and lowered with the aid of a biasing system.

The telescoping column 108 may be made from any suitable material, such as durable plastic, metal and combinations thereof. For instance, the telescoping tubes 108a, 108b, 108c may be made of aluminum. In addition, the tubes 108a, 108b, 108c may be any suitable shape that allows the tubes 108a, 108b, 108c to nest within each other. In one arrangement, the first and second tubes 108a, 108b have a square cross section to provide a flat surface to which tubular levels 130 may be attached. The square tubes also aid in preventing the tubes from rotating within each other. Third tube 108c has a round or circular cross section to allow for mating with a standard type sign post.

As shown in FIG. 7, the sliding collar 110 is arranged around the first tube 108a of the telescoping column 108. The collar 110 surrounds a portion of the first tube 108a and may be any shape that accommodates movement along the length of the tube. For example, the stand 100 includes a first tube 108a having a generally square cross section. Accordingly, the sliding collar 110 also has a generally square cross section. The sliding collar 110 may also include a handle 117 for ease of transporting the stand 100.

As previously discussed, a plurality of support legs 112 are connected to the sliding collar. The plurality of support legs 112 may include any number of legs 112 to suitably support the telescoping column 108 and provide additional stability to the stand 100. For example, the stand 100 of FIG. 7 includes three support legs 112, each arranged to protrude from a side of the first member 108a of the telescoping column 108.

Further to FIG. 7, support legs 112 include points or feet 124 connected to the bottom of each inner support member 112b of the support leg 112. These feet 124 protrude out from the inner support member 112b of the support leg 112 and provide additional stability when the stand 100 is positioned on soft ground or loose soil. For example, when the stand 100 is positioned on the side of a road where the surface may be loose dirt or gravel, the feet 124 may dig into the surface on which the stand 100 is placed, to provide further stability to the stand 100. In addition, a step tab 121 is positioned above the point on the support leg 112b to provide a surface on which a user may step to use his weight to force the foot 124 into the ground.

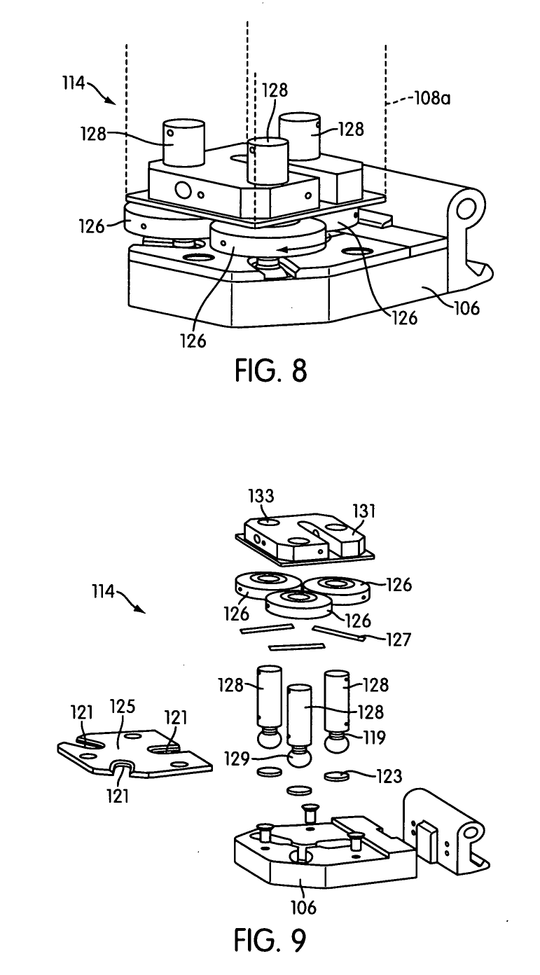

The stand 100 shown in FIG. 7 also includes a leveling system 114, as indicated by the broken circle, and as is shown in detail in FIGS. 8-10. As shown in FIG. 8, the leveling system 114 includes a plurality of knobs 126 connected to pins 128. Pins 128 are connected to a lower base plate 131 of the first tube 108a (partially shown with broken lines), as well as to foundation plate 106. The leveling system 114 may also include a plurality of tubular level indicators (130 in FIGS. 4-7) that indicate when the column 108 reaches a desired vertical orientation.

FIG. 9 is an exploded view of the leveling system 114. The leveling system 114 includes a plurality of knobs 126 for adjusting the orientation of lower base plate 131 relative to foundation plate 106. Each of the knobs 126 is connected to a threaded pin 128. The knobs are secured to the threaded pins via retaining pins 127 that protrude through each knob 126 and its associated threaded pin 128.

Each threaded pin 128 is engaged within a corresponding threaded hole in the base plate 131 of main tube 108a. The opposite end of each threaded pin 128 includes a narrowed neck portion 119 that fits into a slot 121 in support plate 125, and a rounded end 129. The rounded end 129 of each of the threaded pins 128 rests on an insert 123 nested inside a recess in the foundation plate 106. The insert 123 may prevent the rounded end 129 of each pin 128 from wearing the material of the foundation plate 106. For example, the insert may be a brass or TEFLON insert that protects the aluminum of the foundation plate 106.

To level the column 108 using the leveling system 114, one or more of knobs 126 are rotated to raise or lower base plate 131. The movement of the base plate 131 then adjusts the angle of the first member 108a of the telescoping column 108 relative to the foundation plate 106 and base 102 through a conical range of motion that generally surrounds the column.

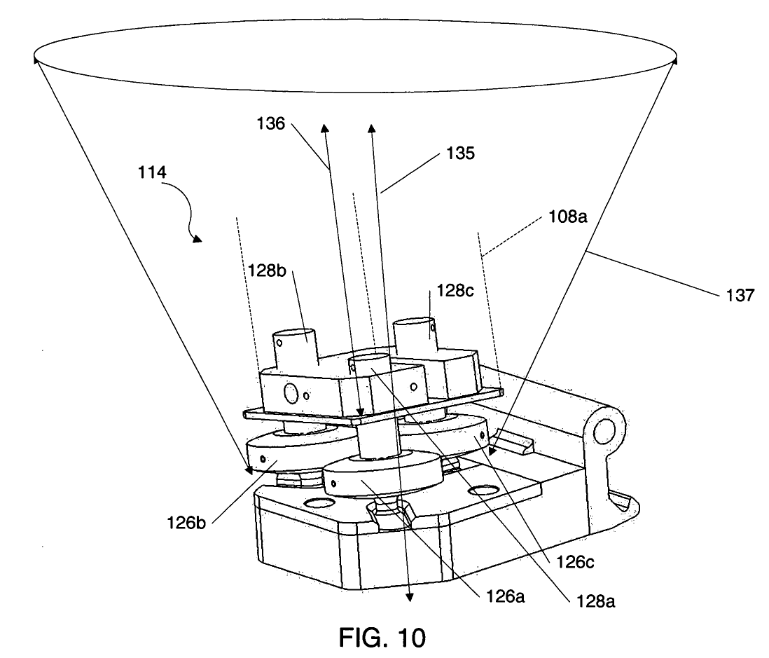

FIG. 10 illustrates a range throughout which the angle of tube 108a relative to the vertical may be adjusted. Axis 135 generally represents a vertical axis relative to the plane of foundation 106 (which may also be the plane of base 102 if foundation 106 is fully unfolded using hinge 116). Axis 136 generally represents a vertical axis relative to the plane of base plate 131. By turning knobs 126a-126c, the distance between base plate 131 and foundation 106 can be adjusted at any of three points. This permits adjustment of axis 136 relative to axis 135 anywhere within a conical region 137. In some embodiments, the column may be adjusted up to 15° in any direction.

To provide an indication of when the column 108 has reached a desired orientation relative to base plate 106, a plurality of tubular bubble levels 130 are arranged on the sides of the first member 108a of the telescoping column 108 (See FIG. 7). As the knobs 126 are rotated, the bubble in each of the tubular levels 130 slides along the level until it comes to rest in a predetermined position on the level (e.g., the center), to indicate that a desired level has been reached. This leveling system 114 allows the stand 100 to be utilized in a variety of environments, not just a level surface. For instance, the sign may be positioned on an incline, such as a shoulder of a road, and the leveling system 114 may be adjusted to ensure that the stand 100 is level, despite the unlevel ground conditions.

In another embodiment of the leveling system, a ball attached to tube 108a may be nested within an expandable socket on the foundation plate. A screw joins portions of the socket and may be tightened to clamp the socket onto the ball when a desired column orientation is achieved.

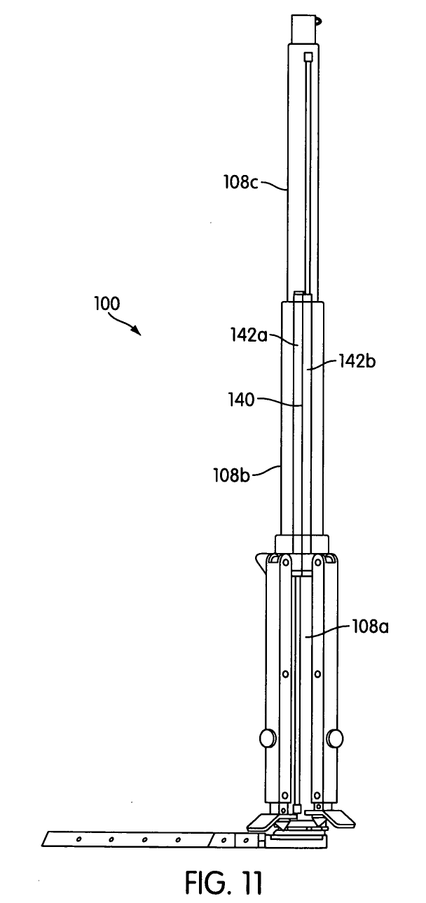

FIGS. 11-14 show a gas spring biasing system 140 according to one configuration that may be used with the stand 100. The biasing system 140 includes a plurality of lockable gas springs 142 that may maintain any number of positions along the length of the column 108. The gas springs 142 are arranged in opposing directions within the telescoping column 108 and provide easier lifting of the telescoping tubes 108b, 108c. A separate gas spring may be provided for each telescoping tube of the telescoping column 108. Gas spring 142a may ease lifting of second tube 108b, and gas spring 142b may ease lifting of third tube 108c. It is, of course, possible to have fewer or more telescoping tubes, and the invention is not limited in this respect.

FIG. 11 is a cross sectional view of the stand 100 in a partially deployed configuration. Specifically, legs 112 have not been unfolded but tubes 108b and 108c are extended their full length. The lockable, opposing gas springs 142a, 142b are visible within the telescoping tubes 108a, 108b, 108c. In this embodiment shown, the gas springs face in opposite directions. That is, one gas spring faces upward, while the other gas spring faces downward.

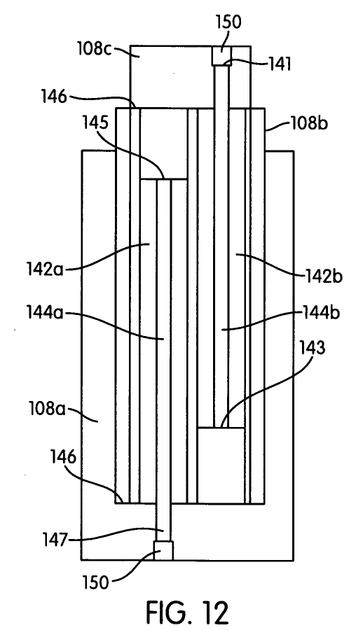

FIG. 12 is a partially schematic view of the gas spring system of FIG. 11. The third telescoping tube 108c is nested within the second telescoping tube 108b, which is nested within the first telescoping tube 108a. The lockable gas springs are arranged within the second telescoping tube 108b in opposing directions. Gas springs 142a, 142b are attached to mounting plates 146 within the second telescoping tube 108b. Gas spring 142a includes an extension rod 144a. The extension rod includes a first end 145 that remains within the gas spring 142a and a second end 147 that may extend out from the gas spring 142a. The second end 147 of the extension rod 144a is attached to a spring mount 150 at the bottom of the first telescoping tube 108a. In addition, gas spring 142b includes an extension rod 144b with a first end 143 that remains within the gas spring 142b and second end 141 that extends out from the gas spring 142b. The second end 141 of the extension rod 144b is attached to a spring mount 150 at the top of the third extension tube 108c.

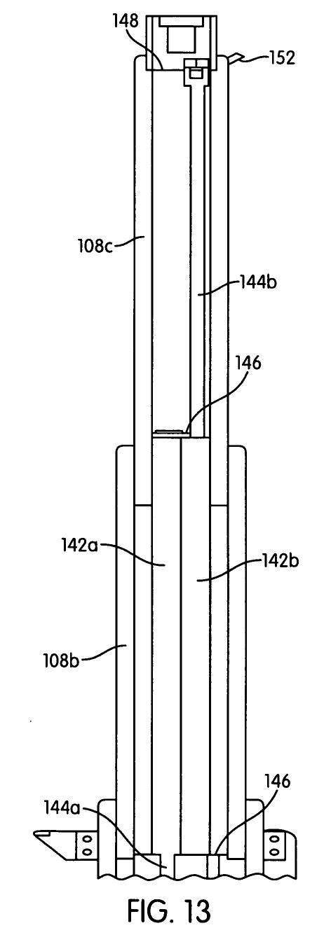

FIG. 13 is an enlarged view of the upper portion of stand 100 shown in FIG. 9. Both gas springs 142a, 142b and the second and third telescoping tubes 108b, 108c are shown. The gas springs are arranged in opposing directions within the second telescoping tube 108b with extension rods 144a, 144b protruding from the gas springs.

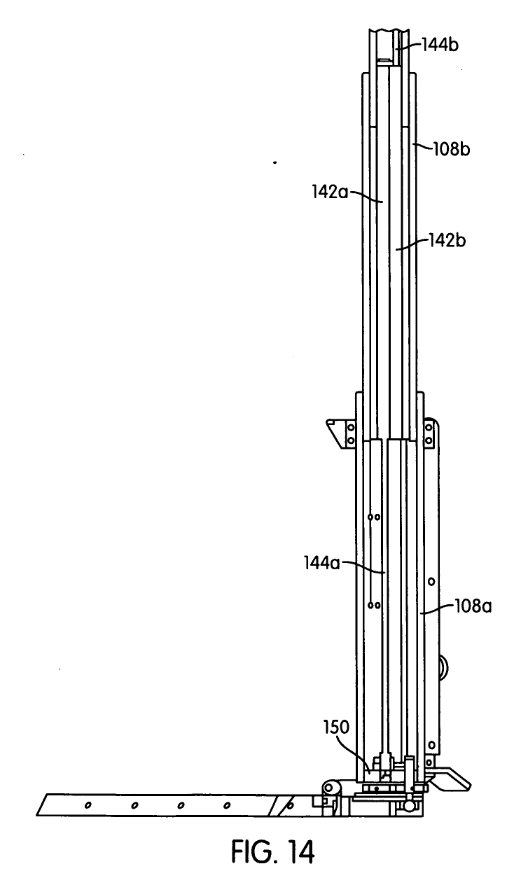

FIG. 14 is an enlarged view of the bottom portion of the stand 100 of FIG. 11. In order to extend the column 108, levers are arranged on the column 108 to release an associated extension rod, thereby forcing the tubes into an extended position. For example, lever 152 in FIG. 13 is positioned to contact a valve located on the gas spring cylinder. As the lever 152 is depressed it contacts the valve to open it and extension rod 144b is released to force third telescoping tube 108c to extend out of its nested position within second telescoping tube 108b. When the lever is released, the valve is closed and the extension rod 144b will maintain its position. This system provides a lockable gas spring that may maintain an infinite number of positions along the length of the column 108. In another example, when the lower lever (not shown) is depressed, extension rod 144a is released to extend out of gas spring 142a and force second telescoping tube 108b out of its nested position with tube 108a. The third telescoping tube 108c remains nested within the second telescoping tube 108b in its raised position. Once the second telescoping tube 108b has reached the desired level, the lever may be released. In order to raise the third telescoping tube 108c, the upper lever (152 in FIG. 13) is depressed to release the third tube as discussed above.

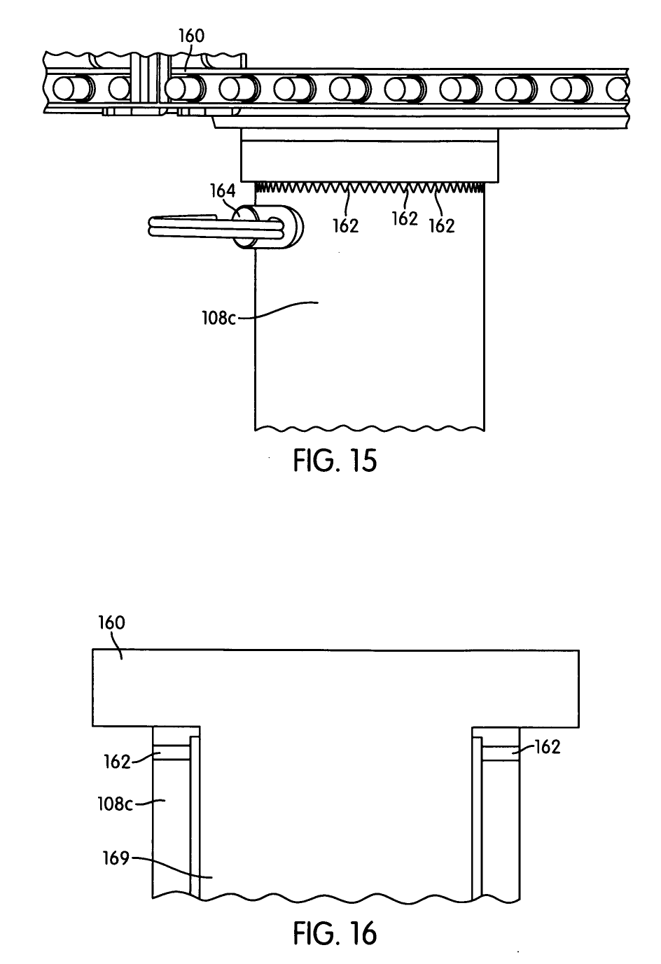

FIG. 15 is an enlarged view of the top portion of the third telescoping tube 108c as coupled to a sign 160. The third telescoping tube 108c includes a plurality of teeth 162 arranged around the top surface, i.e., a top edge. These teeth 162 provide an indexed mating surface for a sign 160 or sign post. The teeth 162 allow the sign 160 to be rotated in specific increments within the third telescoping tube 108c. In one example, 72 teeth allow rotation at 5° increments. In another example, 40 teeth allow rotation of the sign 160 in 9° increments. Once the sign 160 has been arranged as desired, the position of the sign 160 may be maintained with a spring loaded pin 164 that protrudes through the third telescoping tube 108c and contacts the sign 160 or sign post to hold its position.

FIG. 16 is a cross-sectional view of the upper portion of tube 108c and a stem 169 of sign 160. In order to attach the sign 160 to the stand 100, stem 169 is inserted into the third telescoping tube 108c.

Numerous characteristics, advantages and embodiments of the invention have been described in detail in the foregoing description with reference to the accompanying drawings. However, the above description and drawings are illustrative only, and the invention is not limited to the illustrated embodiments. Various changes and modifications may be effected therein by one skilled in the art without departing from the scope or spirit of the invention. Although example materials and dimensions have been provided, the invention is not limited to such materials or dimensions unless specifically required by the language of a claim. The elements and uses of the above-described embodiments can be rearranged and combined in manners other than specifically described above, with any and all permutations within the scope of the invention. As used herein (including the claims), “coupled” includes two components that are attached (movably or fixedly) by one or more intermediate components.

I claim:

1. A collapsible support stand, comprising:
a generally planar base;
a foundation plate coupled to the base and configured for angular movement with respect to the base;
a first support member coupled to the foundation plate and adjustable with respect to the foundation plate throughout a conical range of motion; and
a plurality of legs coupled to the first support member and unfoldable from the support member such that a portion of each leg lies in the same plane as the base.

2. The collapsible support stand of claim 1, wherein the generally planar base is at least 24 inches long.

3. The collapsible support stand of claim 1, further comprising a leveling system, wherein the leveling system includes a base plate coupled to the first support member and a plurality of pins, wherein each of the pins includes a threaded portion and cooperates with a threaded hole in the base plate, and wherein rotation of each pin increases or decreases the distance between the base plate and the foundation plate.

4. The collapsible support stand of claim 3, wherein the leveling system further includes at least one level indicator.

5. The collapsible support stand of claim 1, wherein the first support member has a square cross section.

6. The collapsible support stand of claim 1, wherein the plurality of legs are extendable and further include points for penetrating a surface and step tabs for forcing the points into the surface.

7. The collapsible support stand of claim 1, further comprising a sliding collar surrounding a portion of the first support member wherein the first support member has multiple holes into which a pin is inserted to secure the sliding collar.

8. The collapsible support stand of claim 1, wherein the first support member further comprises three support posts and wherein the top-most post further includes a first plurality of teeth arranged on a top edge and configured for mating with an attachment member having a second plurality of teeth.

9. The collapsible support stand of claim 8, further comprising a spring loaded pin for securing the attachment member inside the top-most post.

10. The collapsible support stand of claim 1, further comprising a gas spring assembly wherein the gas springs are lockable and are arranged in opposite directions and include an extension rod arranged within each gas spring, wherein the extension rods have a first end and a second end, wherein the first end remains within the gas spring while the second end extends out from the gas spring to extend the support member.

11. A collapsible support stand, comprising:
a generally planar base;
a foundation plate coupled to the base and configured for angular movement with respect to the base;
at least three support members coupled to the foundation plate, wherein the second support member includes a gas spring assembly wherein the gas springs are lockable and are arranged in opposite directions and include an extension rod arranged within each gas spring, wherein the extension rods have a first end and a second end, wherein the first end remains within the gas spring while the second end extends out from the gas spring to extend the support member.
a plurality of legs coupled to the first support member and unfoldable from the support member such that a portion of each leg lies in the same plane as the base.

12. The collapsible support stand of claim 11, further comprising a first plurality of teeth arranged on a top edge of the third support member and configured for mating with an attachment member having a second plurality of teeth.

13. The collapsible support stand of claim 12, wherein the first and second plurality of teeth include between 40 and 72 teeth.

14. The collapsible support stand of claim 11, wherein the first and second support members have square cross sections.

15. The collapsible support stand of claim 11, further comprising a leveling system arranged between the foundation plate and first support member.

16. The collapsible support stand of claim 11, wherein the plurality of legs are extendable and further include points for penetrating a surface and step tabs for forcing the points into the surface.

17. The collapsible support stand of claim 11, further comprising a plurality of receiving holes formed in the first support member and configured to allow adjustment of a sliding collar along the first support member, wherein the sliding collar is retained in a position by a locking pin inserted through the sliding collar and into one of the holes.

18. A collapsible support stand, comprising:
a generally concave base at least 24 inches in length;
a foundation plate coupled to the base and configured for angular movement with respect to the base;
at least two square support members coupled to the foundation plate, one support member being nested within the other support member and extendable from the other support member; and
a means for adjusting the orientation of the at least two support members relative to the foundation plate.

19. The collapsible support stand of claim 18, further comprising means for mating an upper edge of one of the support members with a sign or other object

20. The collapsible support stand of claim 18, further comprising means for securing a sliding collar at a selected one of at least three positions along the length of one of the square support members.
